(19) United States
(12) Patent Application Publication
(10) Pub. No.: US 2010/0243002 A1
(43) Pub. Date: Sep. 30, 2010

(54) METHOD AND DEVICE FOR CLEANING A COMPONENT, PARTICULARLY AN EVAPORATOR OF A CONDENSING DEVICE, AND WASHING OR LAUNDRY DRYER HAVING SUCH A DEVICE

(75) Inventors: Klaus Grunert, Berlin (DE); Günter Steffens, Dallgow-Doberitz (DE); Andreas Stolze, Falkensee (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERATE GMBH, Munich (DE)

(21) Appl. No.: 12/680,254

(22) PCT Filed: Oct. 15, 2008
(86) PCT No.: PCT/EP2008/063893

§ 371 Date: Mar. 26, 2010

(30) Foreign Application Priority Data
Nov. 6, 2007 (DE) 10 2007 052 835.5

(51) Int. Cl. B08B 3/00

(52) U.S. Cl. 134/34; 134/104.2

(57) ABSTRACT

A home appliance includes an evaporator of a condenser in a process air circuit, a condensate water pan that collects water condensed by the evaporator from drying of process air, a collector tank above the evaporator having one of a rinsing tank and a rinsing chamber with a storage chamber as an overflow region, and an abruptly openable outlet, and a downpipe connected to the abruptly openable outlet to permit discharge of condensate water in the collector tank in a surge to the evaporator.

The invention relates to a method and a device for cleaning a component disposed within a process air circuit of a washing or laundry dryer, particularly an evaporator of a condenser device, by means of rinsing water which is obtained in particular from condensate water in the process air circuit from the drying of damp laundry and collected in a condensate water pan, from where it is fed into a rinsing tank disposed above the evaporator and from the outlet side thereof is discharged to the relevant evaporator. The invention further relates to a washing or laundry dryer comprising a device of the aforementioned type. It should be noted here that by the term “washing dryer” a combination appliance is understood which has a washing function for washing laundry and a drying function for drying damp laundry. A laundry dryer, in contrast, merely has a drying function for drying damp laundry.

A method and a device of the aforementioned type for removing lint from a condensate water separator configured as a heat exchanger is already known (DE 37 38 031 C2). In the relevant known method and in the device provided for the implementation thereof, a relatively small quantity of approximately half a liter of condensate water is used once for rinsing the plates of the condenser device provided. The relevant rinsing process lasts in this connection approximately 30 seconds. However, a relatively intensive rinsing of the condenser device is required in order to remove effectively from the condenser device lint which remains suspended in the relevant condenser device when drying damp laundry. This requires the use of a relatively powerful pump, however, which pumps the condensate water from the condensate water pan to the rinsing device which is present. There is, however, occasionally the desire to avoid such a high degree of complexity and to manage with a simpler arrangement in order to clean a component disposed within a process air circuit of a washing or laundry dryer, particularly an evaporator of a condenser device by means of the condensate water collected in a condensate water pan.

A device for cleaning the evaporator of a condenser device in a laundry dryer is further known (EP 0 468 573 A1). In this known device, the evaporator of the condenser device consisting of a plurality of plates arranged parallel to one another may be cleaned on its side opposing the condensate water pan by means of a cleaning device. This cleaning device consists of a comb-like brush and/or bristle arrangement which may be moved to and fro, to which condensate water contained in the condensate water pan is additionally fed. In this known device, however, the cleaning of the evaporator of the condenser device is relatively poor, as the comb-like cleaning device is only able to clean the upper region of the evaporator of the condenser device, but not the substantially larger region located thereunder. Said region could be possibly cleaned by the comb-like cleaning device being provided with bristles extending over the entire depth of the evaporator. This would require, however, a relatively high energy consumption and thus a relatively high cost in terms of equipment, provided it would function at all, due to the considerable friction associated therewith between the bristles of the comb-like cleaning device and the side walls of the plates of the evaporator. Such a cost is, however, regarded as undesirable.

Moreover, a method and a domestic laundry dryer for cleaning a portion of a guide for a process air flow is known (DE 199 43 125 A1). In this connection, a fan is provided for producing the process air flow which may be brought into contact in a drying chamber with laundry to be dried for absorbing moisture. Apart from a drying phase, in which by means of the fan the process air flow is produced and brought into contact in the drying chamber with the laundry to be dried, in a cleaning phase when the fan is switched off a portion of the process air guide is at least partially flooded with a liquid for a specific time period. This liquid is then again removed at the end of the cleaning phase from the flooded portion of the process air guide. The relevant liquid is, in particular, condensate liquid from a condensate tank, in which during the drying of the laundry condensate water is collected, which is obtained from drying damp laundry. In order to be able to undertake the aforementioned flooding of the aforementioned one portion of the process air guide, said process air guide has to be sealed by means of a sealing arrangement which, due to the cost associated therewith, however, is sometimes regarded as undesirable. Thus a simpler solution is sought for cleaning a component disposed within a process air circuit of a washing or laundry dryer.

A method for removing lint from a heat exchanger of a domestic appliance as well as a corresponding domestic appliance have been further proposed (official application number 10 2006 061 211.6-internal reference: 200602617), for which a rinsing liquid formed, in particular, by condensate produced during a drying process in the domestic appliance during a cleaning phase is deflected depending on the strength of an air flow and depending on the deflection flows through different regions of the heat exchanger. Thus an efficient cleaning of the heat exchanger may, however, only be achieved with a sufficiently large volume of rinsing liquid and/or with rinsing liquid flowing sufficiently rapidly. How this may be achieved is, however, left open in the relevant context.

Finally, a method and a device has also already been proposed for cleaning a component disposed within a process air circuit of a washing or laundry dryer, particularly an evaporator of a condenser device, by means of condensate water (official application number DE 10 2007 016 074.9—internal reference 200601639) which is obtained in the process circuit from the drying of damp washing and is collected in a condensate water pan, from where it is fed to a rinsing tank disposed above the evaporator and from the outlet side thereof is discharged to the relevant evaporator by abrupt opening of the relevant rinsing tank on the outlet side thereof as a water surge to the aforementioned component. Although, as a result, efficient cleaning of the aforementioned component may already be achieved, the desire remains for even more efficient cleaning of the affected component.

The object of the invention is, therefore, to provide a way in which, in a particularly simple manner, a component disposed within a process air circuit of a washing or laundry dryer, and namely particularly an evaporator of a condenser device, may be cleaned by means of rinsing water more efficiently than hitherto known and than hitherto proposed, without a considerable cost being necessary.

The object set forth above is achieved in a method of the aforementioned type according to the invention by the condensate water being discharged as rinsing water from the rinsing tank or a rinsing chamber of a collector tank comprising said rinsing chamber and an overflow region serving as a storage chamber, by the abrupt opening thereof on the output side as a water surge and/or mains water under pressure to the affected component.

The invention provides the advantage that it is possible by means of a simple method step, namely by discharging the condensate water from the rinsing tank or the rinsing chamber of the aforementioned collector tank as a water surge and/or by discharging mains water under pressure to the affected component, to be able to clean more efficiently a component disposed within a process air circuit of a washing or laundry dryer, and namely in particular an evaporator of a condenser device, than previously known and than previously proposed and namely in particular of lint, which has collected there during a drying process of damp laundry. For example, if a quantity of condensate water of 2.5 liters is assumed, which has collected in the rinsing tank, an efficient cleaning of the component and/or evaporator of the condenser device is thus achieved by said quantity of condensate water being discharged in a surge-like manner within a timespan of approximately 1 s to 2 s. In the case of a discharge of 2.5 liters of condensate water within 1 s, this corresponds to a discharge quantity of 150 liters/min of condensate water. In the case of the condensate water discharge within 2 s taken as an example, this corresponds to a condensate water discharge of 75 liters/min. Such water quantities could, moreover, —should it be desired to used a pump for the discharge thereof—only be discharged by a relatively large-volume and powerful feed pump, the use thereof however not being able to be considered in washing or laundry dryers for the supply of condensate water for cleaning components disposed there within the process air circuits and namely, in particular, evaporators of condenser devices. By the alternative or additional discharge of the mains water under pressure to the component to be cleaned, at a conventional mains water pressure of, for example, 3 bar, an even more efficient cleaning of the affected component to be cleaned is achieved.

It should be noted here that by “mains water” is understood mains water available in the domestic environment, which normally is provided at a mains water pressure of at least 3 bar, occasionally however even at a higher pressure, such as for example 6 bar.

Preferably, the water surge to be discharged to the component is substantially equalized in its discharge quantity between the start and finish of the discharge process. As a result, there is the advantage of a relatively uniform rinsing action on and/or in the component to be cleaned between the start and finish of the discharge of the water surge.

According to a further expedient embodiment of the present invention, in an evaporator of a condenser device forming the aforementioned component, the water surge and/or the mains water under pressure is preferably discharged to an evaporator region merely located at a fixed distance from the inlet region of the process air into the evaporator. This provides the advantage that in the entire inlet region of the evaporator, deposits in the form of lint which usually increasingly occur may be effectively removed. Thus the water discharge is preferably carried out directly after finishing a drying process of damp laundry to be dried, as at this time contaminants adhering to the aforementioned component and/or evaporator of the condenser device, in particular lint, are still damp and may be removed relatively easily by the discharged rinsing fluid.

According to a further expedient development of the present invention, in an evaporator of a condenser device forming the aforementioned component, the discharge of the water surge and/or of the mains water under pressure is carried out by mechanical, hydraulic, pneumatic or electromechanical deflection from a starting region provided at the inlet region of the process air into the evaporator to an end region located at a distance therefrom in the direction of the outlet region of the process air from the condenser. As a result, there is the advantage that a cleaning of the component to be cleaned, and namely in particular of the evaporator of a condenser device, may be undertaken in a relatively simple manner over a region which may be fixed. The relevant region may thus extend from the inlet region of the process air into the evaporator as far as the outlet region from the evaporator. The rinsing water discharge is also carried out in this case preferably immediately after finishing a process of drying damp laundry to be dried, as at this time contaminants adhering to the aforementioned component and/or evaporator of the condenser device, in particular lint, are still damp and may be easily removed by the rinsing fluid discharged in a surge-like manner.

Expediently, the condensate water is pumped by means of a pump from the condensate water pan into the rinsing tank and/or the rinsing chamber of the aforementioned collector tank. This represents a relatively simple possibility for the provision of the condensate water, which is discharged as surge water for cleaning the component formed, in particular, by an evaporator of a condenser device. In this connection it is possible advantageously to manage with a relatively small pump of low power, in order to pump the condensate water from the condensate water pan into the rinsing tank and/or the rinsing chamber of the aforementioned collector tank. The power of such a pump is markedly below the power of a pump, in particular in terms of order of magnitude, as has been mentioned above in connection with the principal embodiment of the present invention.

Advantageously, the abrupt opening of the rinsing tank and/or the rinsing chamber of the aforementioned collector tank on the outlet side thereof is controlled by actuating a bistable rinsing tank closure. This provides the advantage of a particularly effective abrupt opening of the rinsing tank and/or rinsing chamber of the aforementioned collector tank on the outlet side thereof. In this connection, it is advantageously possible to utilize the effect that by a relatively short actuating stroke on the control side a relatively large stroke on the control side of an actuating member may be achieved for actuating the rinsing tank closure. Moreover, advantageously for the actuation of the bistable rinsing tank and/or rinsing chamber closure a so-called jump function provided to the bistable rinsing tank closure may be utilized, by which an abrupt movement of the rinsing tank and/or rinsing chamber closure may be executed for the opening thereof and also may be executed for the closure thereof.

Preferably, the aforementioned actuation of the rinsing tank and/or rinsing chamber closure takes place thermally or electromagnetically. This provides the advantage of a particularly simple actuation of the rinsing tank and/or rinsing chamber closure.

For carrying out the method according to the invention, preferably a device is used with a component to be cleaned disposed within a process air circuit of a washing or laundry dryer, particularly an evaporator of a condenser device, and comprising a condensate water pan, into which condensate water produced in the process air circuit by the drying of damp laundry may be collected, may be fed therefrom to a collector tank disposed above the evaporator, and may be discharged therefrom to the affected component. This device according to the invention is characterized in that the aforementioned tank provided as a rinsing tank or a rinsing chamber of a collector tank comprising said rinsing chamber and an overflow region serving as a storage chamber, on its outlet side comprises a closure part, through the abrupt opening thereof the rinsing tank and/or the rinsing chamber permits the discharge of the condensate water contained therein in a surge-like manner through a downpipe to the aforementioned component and that alternatively or additionally to the discharge of the condensate water from the rinsing tank and/or the rinsing chamber a supply pipe guiding mains water under pressure on the output side permits the relevant mains water to be discharged to the aforementioned component.

This provides the advantage of a device of particularly low complexity, for particularly efficient cleaning of a component disposed within a process air circuit of a washing or laundry dryer, and namely in particular of an evaporator of a condenser device. By the abrupt opening of the rinsing tank or the rinsing chamber on the outlet side thereof, namely the condensate water collected in the rinsing tank and/or the rinsing chamber in an efficient manner may be rapidly discharged as a water surge to the component to be cleaned, without additional devices being necessary. As an alternative or in addition to the discharge of the water surge to the component to be cleaned, mains water under pressure may be discharged thereto for cleaning. In the case of the additional or even the exclusive cleaning of the aforementioned component by means of mains water under pressure, as a result of the mains water pressure which is normally at least 3 bar, a particularly intensive cleaning action may be achieved.

Expediently, the aforementioned downpipe has a region which is narrowed relative to the cross section of the outlet region of the rinsing tank and/or the rinsing chamber. As a result, in a relatively simple manner an efficient equalization of the surge water discharge between the start and finish thereof may be achieved.

According to a further expedient embodiment of the invention in an evaporator of a condenser device forming the aforementioned component, the water surge and/or the mains water under pressure may be preferably discharged to an evaporator region merely located at a fixed distance from the inlet region of the process air in the evaporator by means of a rinsing nozzle connected to the downpipe and arranged fixedly thereon. This provides the advantage of a particularly effective cleaning of the region of the evaporator primarily to be cleaned, in which the process air enters and, in particular, deposits contaminants there such as lint.

According to a further expedient development of the present invention, the rinsing nozzle and/or the downpipe during the discharge of the water surge and/or the mains water under pressure may be deflected by a mechanically, hydraulically, pneumatically or electromechanically actuated deflection device from a starting region located at the inlet region of the process air into the evaporator of the condenser device to an end region located at a distance therefrom in the direction of the outlet region of the process air from the evaporator. This provides the advantage that the evaporator of the condenser device may be cleaned by the aforementioned water surge over a length which may be fixed, which in particular may be its entire length, over which process air flows.

Expediently, the rinsing tank and/or the rinsing chamber is connected to the condensate water pan by means of a pump. This provides the advantage that the rinsing tank and/or rinsing chamber may be filled in a relatively simple manner with condensate water.

Preferably, the closure part of the rinsing tank and/or the rinsing chamber is connected to a bistable spring arrangement, which may be actuated for opening the outlet region of the rinsing tank and/or rinsing chamber closed by the closure part. As a result, there is the advantage that the closure part of the rinsing tank and/or the rinsing chamber may be particularly reliably opened by the bistable action of the spring arrangement. The relevant opening may thus preferably take place particularly rapidly by a jump function being provided to the relevant bistable spring arrangement for switching into the respective bistable position thereof.

For the above-mentioned actuation of the bistable spring arrangement preferably a thermal relay or magnetic relay coupled thereby is provided. As a result, there is the advantage that for activating the bistable spring arrangement a particularly small outlay is sufficient.

The present invention is described in more detail hereinafter by way of example and with reference to the drawings, in which:

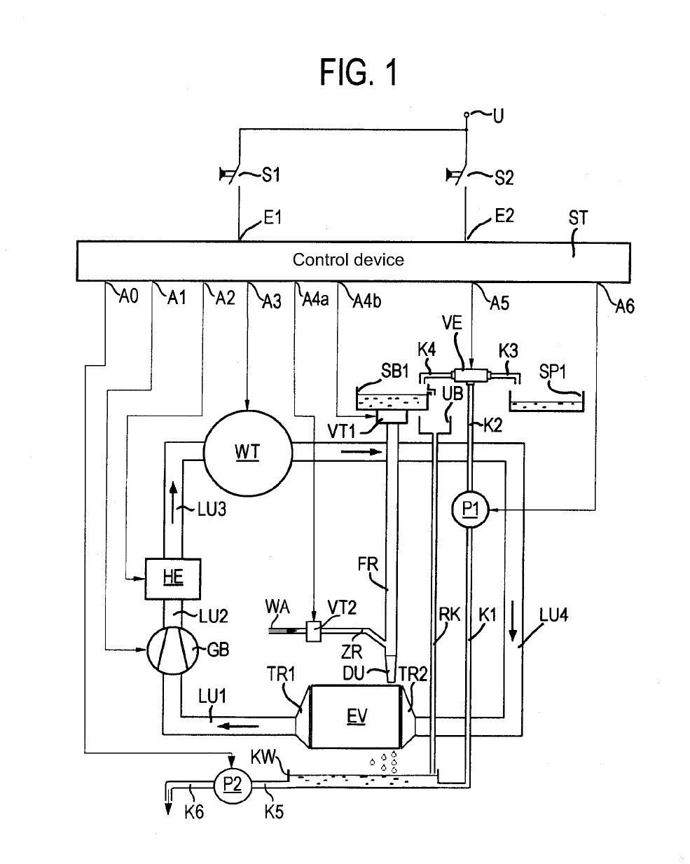

FIG. 1 shows in a schematic view a device according to a first embodiment of the present invention,

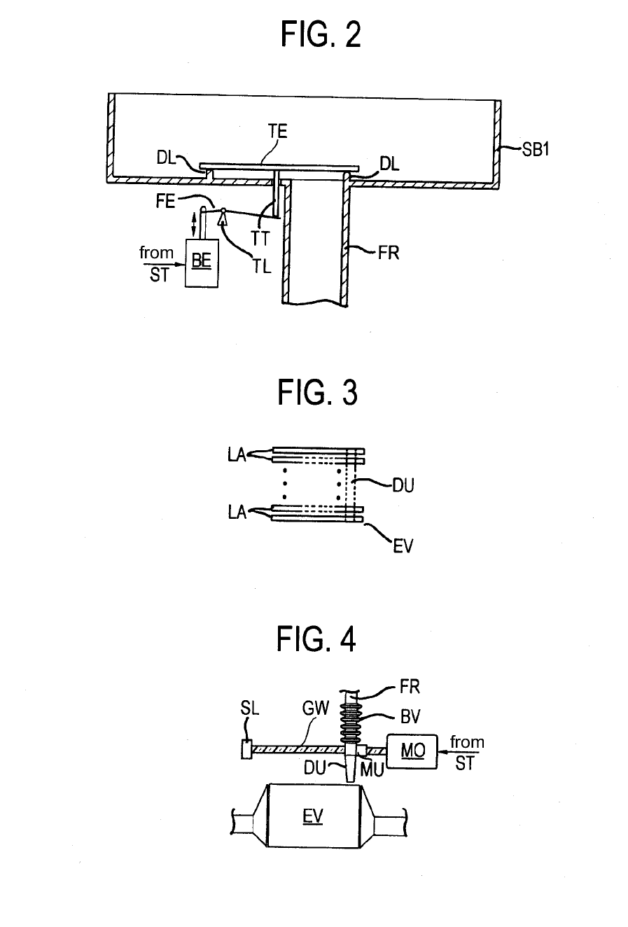

FIG. 2 shows, in an enlarged view and partially in section, a rinsing tank containing condensate water provided in the device according to FIG. 1, with an actuating device for the discharge of the condensate water located in the rinsing tank in a surge-like manner,

FIG. 3 shows in a schematic view a plan view of an evaporator of a condenser device, as is provided in the device shown in FIG. 1,

FIG. 4 shows an arrangement through which the condensate water, discharged in a surge-like manner from the rinsing tank in the device according to FIG. 1, may be discharged via a region of the evaporator of the condenser device which may be fixed,

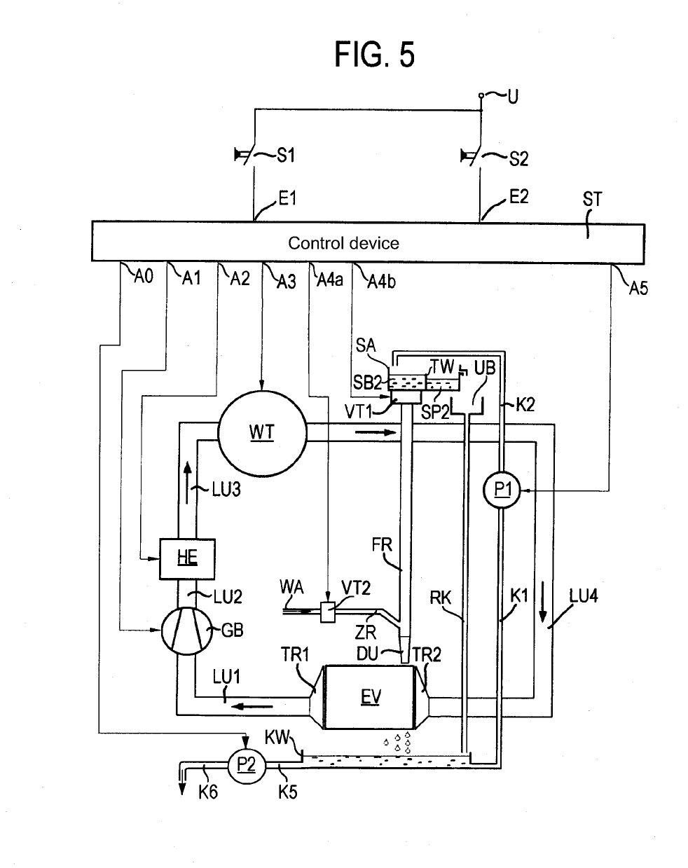

FIG. 5 shows in a schematic view a device according to a second embodiment of the present invention,

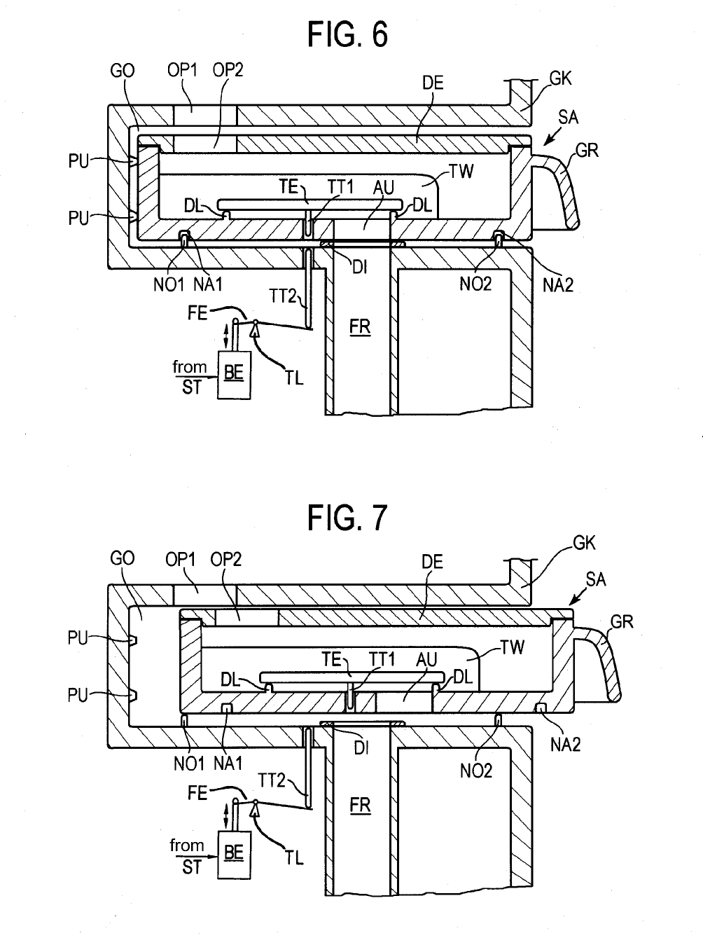

FIG. 6 shows in an enlarged view and partially in section a collector tank provided in the device according to FIG. 5 and containing condensate water, inserted into an appliance body and substantially closed on its upper side by a cover, with an actuating device for the surge-like discharge of the condensate water located in the collector tank,

FIG. 7 shows in an enlarged view the collector tank shown in FIG. 6, in a state partially withdrawn from the aforementioned device body,

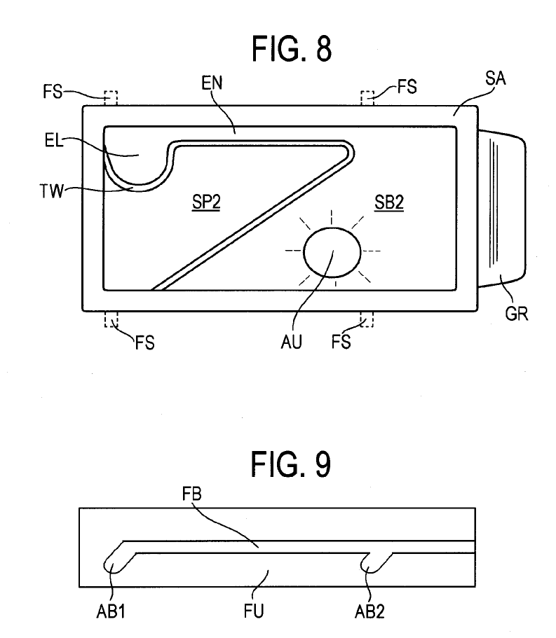

FIG. 8 shows in a plan view the collector tank shown in FIGS. 6 and 7 with the cover removed and

FIG. 9 shows a schematic view of a possible guide device for the collector tank shown in FIG. 8.

Before more details are provided about the drawings, it should be noted firstly that the same elements and/or devices are denoted in all figures by the same reference numerals.

The device shown in FIG. 1 in a schematic view according to the first embodiment of the present invention is contained in a washing or laundry dryer, of which in FIG. 1 however only the parts essential for operation are shown for understanding the present invention. Included in these parts is primarily a washing or laundry drum WT containing damp laundry to be dried and a process air flow arrangement connected thereto and considered below in more detail, through which process air flows in the direction of the arrows provided in FIG. 1.

The process air flow arrangement comprises a series of process air channels LU1, LU2, LU3 and LU4 as well as devices connected thereto, namely a fan GB, a heating device HE and an evaporator EV of a condenser device, not shown here in more detail. The evaporator EV is thus connected on the outlet side via a funnel-shaped connector TR1 serving as a transition part, to the one end of the process air channel LU1, to which cold, dry process air is supplied, and which is connected with its other end to an input connector of the fan GB. This fan GB is connected on the output side via the process air channel LU2 to the input side of the heating device HE, which on the output side is connected through the process air channel LU3 to the input side of the washing or laundry drum WT for the supply of now hot, dry process air. On the output side, the washing and/or laundry drum WT is connected to the input side of the evaporator EV for deflecting hot, damp process air which is discharged from damp laundry to be dried therein, through the process air channel LU4 and a funnel-shaped connector TR2 connected thereto, also serving as a transition part. The condensing of the moisture of the hot damp process air supplied by the process air channel LU4 from the washing and/or laundry drum WT takes place in this evaporator EV. The condensate water produced thereby in the evaporator EV enters, as indicated in FIG. 1, in the form of water droplets into a condensate water pan KW arranged below the evaporator EV, in which it is collected.

The condensate water collected in the condensate water pan KW now has to be discharged therefrom, so that an overflow does not result. To this end, the condensate water pan KW in the present case is connected by a connecting channel K1 to the input side of an electrical pump P1 which, for example, may be an impeller pump. On the output side, the pump P1 is connected by a connecting channel K2 to the input side of a distributor VE, which in the present case may be a controllable two-way valve. The relevant distributor and/or the two-way valve VE has two output connectors, one thereof being connected to a connecting channel K3 and the other thereof being connected to a connecting channel K4.

The connecting channel K3 is used so that condensate water, discharged through said connecting channel and pumped upward by means of the pump P1 from the condensate water pan KW, is discharged into a special storage tank SP1 provided in the upper region of the washing or laundry dryer containing the device according to the invention. This storage tank SP1 may, for example, be a storage tank which may be manually removed from the washing or laundry dryer in which the described device is contained, via which the condensate water pumped upward therein from the condensate water pan KW may be disposed of.

The connecting channel K4 serves to discharge on the output side condensate water supplied thereto by the distributor and/or two-way valve VE to a rinsing tank SB 1. This rinsing tank SB 1 which is arranged in the washing or laundry dryer containing the device shown, is arranged as far as possible on the upper side thereof and which may have the same storage capacity as the condensate water pan KW or the storage tank SP1, for example for receiving 2.5 liters of condensate water, and for the sake of safety—as shown—is provided with an overflow arrangement, through which condensate water possibly overflowing from the rinsing tank SB1 passes into an overflow tank UB, which is directly connected to the condensate water pan KW by a return channel RK and may discharge condensate water entering therein directly to the condensate water pan KW.

The condensate water collected in the condensate water pan KW may, on the other hand, be pumped out through a connecting channel K5 by means of an electrical pump P2 which may, for example, be an impeller pump, into a connecting channel K6, which may lead to a waste water disposal arrangement such as a water drainpipe.

The rinsing tank SB 1 is connected to a downpipe FR with its output side and/or outlet side via a normally closed closure part VT1, which may be opened by actuation and/or activation. This downpipe FR, having a relatively large cross section, preferably has a length establishing a drop height of approximately 500 mm to 600 mm for the condensate water to be discharged in a surge-like manner respectively from the rinsing tank SB 1. At its lower end in FIG. 1 it is provided with a fixedly arranged rinsing nozzle DU extending over the entire width of the evaporator EV, comprising an outlet region which is approximately oval-shaped with a width of approximately 6 mm to 10 mm, which with the longitudinal middle of its outlet region is arranged at a fixed distance which in this case is approximately 10 mm to 50 mm from the inlet region of the evaporator EV located to the right in FIG. 1 for hot, damp process air. By this arrangement of the downpipe FR and rinsing nozzle DU, condensate water emerging from the rinsing tank SB 1 when the closure part VT 1 is open may be preferably discharged as a water surge to an evaporator region merely located at a fixed distance from the inlet region of the process air into the evaporator EV. The dimensions of the through-opening of the closure part VT1 as well as the cross section of the downpipe FR and the rinsing nozzle DU, are thus preferably selected so that the condensate water collected in the collector tank SB1—i.e. according to the above example taken, approximately 2.5 liters of condensate water—is discharged as a water surge to the evaporator EV within a very short timespan of 1 to 2 seconds. By the discharge of such a water surge, i.e. at a speed of at least 2.5 liters in 2 seconds and preferably immediately after carrying out a drying process of the damp laundry, which is located in the washing and/or laundry dryer WT for drying, in a particularly effective manner it is possible to rinse away from the aforementioned process air inlet region of the evaporator EV and beyond this region lint and other contaminants which have been fed there through the process air channel LU4 and the funnel-shaped connector TR2.

In order to achieve a substantially uniform discharge quantity of the water surge between the start and finish of its discharge, it has proved expedient if the downpipe FR has a region of which also the rinsing nozzle DU forms part, which is narrowed relative to the cross section of the outlet region of the rinsing tank SB 1. In this connection, however, it has to be ensured that the above indicated minimum quantity of condensate water is provided per time unit for rinsing the evaporator EV.

Additionally or alternatively to the above-mentioned surge-like discharge of the condensate water contained respectively in the rinsing tank SB 1 to the evaporator EV, according to the present invention normal mains water under pressure may be discharged for cleaning. To this end, a water feed pipe WA is provided, to which the relevant mains water under pressure is supplied. At the discharge side of the relevant water feed pipe WA according to FIG. 1 a closure part VT2 is connected which, for example, may be a standard shut-off valve. On the outlet side of the closure part VT2 a water discharge pipe ZR is provided, which in the lower region of the downpipe FR protrudes into said downpipe, i.e. according to FIG. 1 above the rinsing nozzle DU of the relevant downpipe FR. In this manner, in addition to the condensate water discharged in a surge-like manner from the rinsing tank SB 1 the mains water may be discharged for cleaning the evaporator EV, or it may also be discharged on its own to the evaporator EV for the cleaning thereof. In order to avoid, therefore, an overflow of the condensate water pan KW, the condensate water collected therein is respectively pumped out by means of the aforementioned pumps P1 and P2. Thus it is clear that by means of the pump P1, only the portion of the condensate water respectively collected in the condensate water pan KW1, which corresponds to the collecting capacity of the rinsing tank SB1 and/or of the storage tank SP1, has to be pumped out. The excess portion of condensate water which is discharged to the condensate water pan KW is able to be pumped out by means of the pump P2 into the aforementioned drainage arrangement.

By this alternative or additional discharge of mains water for cleaning the evaporator EV, said evaporator may be cleaned extremely well. The relevant discharge of mains water for cleaning the evaporator EV is of particular significance, in particular with a washing dryer, which in any case has a mains water feed device and a mains water drainage device. Due to the exclusive use of mains water under pressure for cleaning the evaporator EV, at least some of the above-considered devices, namely the rinsing tank SB1 with the closure part VT1, the distributor VE as well as the overflow tank UB with the return channel RK and the connecting channel K4, as well as the downpipe FR could be entirely dispensed with. The storage tank SP1, the pump P1 and the connecting channels K1, K2 and K5 may, however, be retained.

The last-considered devices may, however, also be additionally provided in a washing dryer, in order to discharge condensate water collected in the rinsing tank SB1, in addition to the mains water discharged to the evaporator EV for the cleaning thereof. By the combined discharge of mains water under pressure and the condensate water discharged in a surge-like manner from the rinsing tank SB1, an even more efficient cleaning of the evaporator EV may be achieved than simply by the discharge of mains water or condensate water to said evaporator EV.

The first embodiment of the device shown in FIG. 1 according to the present invention is, on the other hand, also able to be used in a laundry dryer, in which only damp laundry may be dried. In this case, the relevant laundry dryer—which normally manages to operate without connections to a water supply and to a water drain—has to be supplied in the water feed pipe WA with mains water, i.e. has to be connected to a corresponding mains water connection and, moreover, the connecting channel K6 shown in FIG. 1 has to be connected to a waste water discharge arrangement.

Relative to the cleaning of the evaporator EV with mains water and/or condensate water from the rinsing tank SB1, the same conditions are present in a laundry dryer as have been explained above in connection with a washing dryer.

For controlling the different devices shown in FIG. 1, as have been mentioned above, a control device ST is provided. This control device ST may, for example, comprise a microcontroller with integral software or a microprocessor control system with a CPU, a ROM memory containing an operating program and a working program, and a RAM working memory as well as interface circuits, to which actuating signals are supplied on the input side and which permit control signals on the output side to be emitted to the different devices of the equipment shown in FIG. 1.

The control device ST has according to FIG. 1, for example, two input connections E1 and E2, to which switches S1 and/or S2 are connected which are respectively applied to a voltage supply U which, for example, may supply a voltage of +5V. On the output side, in the present case the control device ST has, for example, eight output connections A0, A1, A2, A3, A4a, A5a and A6.

The output connection A0 is connected to a control input of the pump P2, by the operation thereof condensate water collected in the condensate water pan KW may be pumped out through the connection channels K5 and K6 to a waste water receiving device such as to a drainpipe.

The output connection A1 of the control device ST is connected to a control input of the fan GB, which may be switched on or off by control signals supplied thereto at this control input.

The output connection A2 of the control device ST is connected to a corresponding control input of the heating device HE, which may be switched on or off by control signals supplied to said control input.

The output connection A3 of the control device ST is connected to the washing and/or laundry drum WT via a connection simply understood as an operative connection, which may be set in rotation or brought to a standstill via control signals emitted via the relevant connection. This means that the relevant control signals from the output connection A3 of the control device ST are emitted to an electrical drive motor connected to the washing and/or laundry drum WT.

The output connection A4a of the control device ST is connected to an actuating input of the closure part VT2, which is either closed or fully opened by control signals supplied thereto from the output connection A4a of the control device ST. It is, however, also possible that the closure part VT2 which may preferably be an electrically actuated closure valve as mentioned above, is normally closed, and may only be fully opened by a control signal emitted from the output connection A4b of the control device ST (for example corresponding to a binary signal “1”).

The output connection A4b of the control device ST is connected to an actuating input of the closure part VT which is either closed or fully opened by control signals supplied thereto from the output connection A4b of the control device ST. It is, however, also possible that the closure part VT is normally closed and may only be fully opened by a control signal emitted from the output connection A4 of the control device ST (for example corresponding to a binary signal “1”).

The output connection A5 of the control device ST is connected to a control and/or actuating input of the distributer and/or two-way valve VE. By control signals emitted via this connection to the closure part and/or two-way valve VE, the relevant closure part and/or two-way valve VE may discharge condensate water supplied thereto by means of the pump P1 from the condensate water pan KW, either to the connecting channel K3 or to the connecting channel K4 or inhibit such a discharge to both connecting channels K3 and K4.

The output connection A6 of the control device ST is connected to a control input of the aforementioned pump P1 which, upon control signals supplied thereto by this connection, may be set in motion for a pump process or be brought to a standstill.

With regard to the above-considered control device ST with its input connections E1 and E2 and output connections A0 to A6, it should also be mentioned that by closing the switch S1 connected to the input connection E1 of the control device ST, for example, the normal drying operation of damp laundry located in the washing and/or laundry drum WT is initiated and carried out and by closing the switch S2 connected to the input connection E2 of the control device ST, the discharge of condensate water from the rinsing tank SB1 opened abruptly is controlled as a water surge to the evaporator EV. In this connection, the actuation of the two switches S1 and S2 may only be undertaken so that in each case only one of the two switches S1 and S2 may be actuated. The relevant switches S1 and S2 may, moreover, be formed in each case by a pushbutton switch.

The supply of the condensate water in the rinsing tank SB1 from the condensate water pan KW may, for example, take place in a program-controlled manner, preferably during a drying operation or after the termination thereof automatically or specifically by manual intervention in the program control of the washing or laundry dryer containing the disclosed device. In the case of such a manual intervention in the program control, the control device ST could be connected by a further input via a further switch (not shown) to the voltage connection U. As the surge-like discharge of the condensate water contained in the rinsing tank to the evaporator EV takes place after the termination of a drying process, lint and other contaminants adhering to the plates LA thereof (see FIG. 3) may be easily rinsed away by the relatively high flow velocity and the relatively large quantity of condensate water. This rinsing process may be carried out with the relevant condensate water once or repeatedly, as required. To this end, then, the condensate water collected again in the condensate water pan KW has to be respectively pumped up into the rinsing tank SB1, from which it is then discharged again in a surge-like manner to the evaporator. After the termination of the cleaning and/or rinsing process, the condensate water collected in the condensate water pan KW either has to be discharged into a waste water system present or pumped into the collector tank SA, which then has to be manually emptied.

Alternatively or additionally to the above-considered rinsing process such a rinsing process and thus a cleaning of the evaporator EV may take place by mains water under pressure, which is supplied to the relevant evaporator EV via the water feed pipe WA, the closure part VT2 and the water discharge pipe ZR. In this case, the control device ST emits a corresponding control signal to the closure part VT2 for the opening thereof, alternatively or additionally to the discharge of a control signal opening the closure part VT1.

In FIG. 2 the rinsing tank SB1 indicated schematically in FIG. 1 is illustrated in an enlarged sectional view in more detail with its closure part. The closure part VT1, shown only schematically in FIG. 1, is formed according to FIG. 2 by the rinsing tank SB1 in the region of the downpipe FR connected thereto having sealing regions and/or sealing lips DL, against which in the closed state of the closure part a closure plate TE bears sealingly with its underside. This closure plate TE has in the central region on its underside a support part TT which runs through a bottom part of the rinsing tank SB1 in a sealed manner and with its lower end bears against an end region of a relatively long pivoting part of a bistable spring FE. This bistable spring FE, formed for example by a leaf spring, which is preferably provided with a jump function, is carried at its bearing point by a fixedly arranged support part TL, around which the relevant bistable spring FE upon actuation may be snapped. At the end of its relatively short pivoting range away from the support part TL, the bistable spring FE is connected to a plunger of an actuating device BE. This actuating device BE may preferably be an actuating device operating thermally or electromechanically, such as a thermal relay or a magnetic relay, which may be activated by the control device ST1 (from the output connection A4b thereof according to FIG. 1). By this transformation ratio between the pivoting ranges of the bistable spring FE provided on both sides of the support part TL a relatively short stroke of the plunger of the actuating device BE may trigger a substantially greater stroke of the closure plate TE relative thereto (lever principle), and namely preferably due to the bistable jump function of the spring FE, so that the condensate water contained in the rinsing tank SB1 may be discharged as a water surge through the downpipe FR and the rinsing nozzle DU to the evaporator EV according to FIG. 1.

FIG. 3 shows in a schematic view a plan view of the evaporator EV in the device shown in FIG. 1. In this connection it is visible from FIG. 3 that the evaporator EV consists of a series of plates LA extending parallel to one another. These plates LA are formed by metal plates, which are cooled in the aforementioned condenser device such that moisture of the damp process air supplied thereto from the right-hand side in FIG. 3 to the cold surfaces of the plates LA condenses and, as indicated in FIG. 1, leads to the discharge of condensate water and/or mains water to the condensate water pan KW shown there. In FIG. 3, the fixed position of the rinsing nozzle DU relative to the evaporator EV is indicated.

Whilst in the evaporator EV shown in FIGS. 1 and 3, the rinsing nozzle DU is respectively arranged fixedly relative to the evaporator EV, FIG. 4 shows a device in which the rinsing nozzle DU may be displaced, more specifically may be deflected, relative to the evaporator EV. According to FIG. 4, above the evaporator EV of the aforementioned condenser device a drive device is provided, which consists of an electric motor MO controllable by the control device ST, a threaded spindle GW able to be rotated thereby as well as a nut part MU coupled thereto, which in the present case is connected to the rinsing nozzle DU. The threaded spindle GW is, as indicated in FIG. 4, at its end remote from the motor MO borne by a support bearing SL.

The rinsing nozzle DU is, according to FIG. 4, connected to the downpipe FR by a movable connecting part BV which, for example, may be formed by a bellows part or a corrugated hose. By this displaceability of the rinsing nozzle DU relative to the evaporator EV, the rinsing nozzle DU during the discharge of a water surge and/or mains water may be deflected from a starting region located at the inlet region of the process air in the evaporator EV of the condenser device to an end region located at a distance therefrom in the direction of the outlet region of the process air from the evaporator EV. This means that the plates LA of the evaporator EV according to FIG. 3 may be rinsed over a fixed length, for example over their entire length, by means of the condensate water and/or mains water discharged in a surge-like manner through the downpipe FR and the rinsing nozzle DU.

In addition, it should be mentioned that the above-described surge-like discharge of the condensate water passing through the downpipe FR and the rinsing nozzle DU and/or the mains water may also be undertaken from a starting region located at the inlet region of the process air into the evaporator EV of the condenser device to an end region located at a distance therefrom in the direction of the outlet region of the process air from the evaporator EV, by the downpipe FR together with the rinsing nozzle DU being correspondingly deflected. Moreover, the aforementioned deflection may also take place in a different manner from that illustrated in FIG. 4, i.e. generally by a deflecting device actuated mechanically, hydraulically, pneumatically or electromechanically.

The device shown in FIG. 5 in a corresponding schematic view as has been used in FIG. 1, is now considered according to the second embodiment of the present invention. As the device shown in FIG. 5 substantially corresponds to the device shown in FIG. 1, it should be sufficient merely to provide details about those features in which this device differs from the device shown in FIG. 1.

The device shown in FIG. 5 according to the second embodiment of the present invention differs from the device shown in FIG. 1 substantially in that the two tanks provided in the device according to FIG. 1, namely the rinsing tank SB 1 and the storage tank SP1, are combined to form a single collector tank SA which is subdivided by a partition wall or intermediate wall TW into a rinsing region and/or a rinsing chamber SB2 and into an overflow region serving as a storage chamber SP2. The condensate water pumped up by the pump P1 from the condensate water pan KW passes through the connecting channel K2 initially into the rinsing region and/or the rinsing chamber SB2. As the partition wall TW, as is visible from FIG. 5, is slightly lower in height than the height of the edge regions of the collector tank SA representing a combination tank or, in short, combi-tank, initially the rinsing region and/or the rinsing chamber SB2 is filled with condensate water from the condensate water pan KW. If the rinsing chamber SB2 of the collector tank SA is filled with condensate water, further condensate water supplied thereto enters the storage chamber SP2 as overflow water via the partition wall TW, in which it initially remains. Via the storage chamber SP2 possibly overflowing condensate water also passes in this case, as in the device shown in FIG. 1, for the sake of safety through an overflow arrangement into the return channel RK and thus again directly back into the condensate water pan KW.

Condensate water collected in the rinsing chamber SB of the collector tank SA, as in the rinsing tank provided in the device according to FIG. 1, may be discharged by abrupt opening of the closure part VT1 in a surge-like manner to the downpipe FR for cleaning the evaporator EV.

The collector tank SA may, as is the storage tank SP1 in the device shown in FIG. 1, be a manually removable collector tank, through which the condensate water pumped up therein from the condensate water pan KW may be disposed of, and namely in particular the condensate water contained in the storage chamber SP2, after the condensate water collected in the rinsing chamber SB1 has been discharged for cleaning the evaporator EV. The disposal of the condensate water from the collector tank SA may take place by the relevant collector tank SA being completely removed from the washing and/or laundry dryer and emptied into a waste water drainage device. This emptying may take place manually. However, it is also possible that the condensate water contained in the storage chamber SP2 is pumped out by means of an electrically actuated pump and diverted into the aforementioned waste water drainage device.

In FIGS. 6 and 7, the collector tank SA indicated only schematically in FIG. 5 is illustrated in more detail in a possible embodiment. FIGS. 6 and 7 show the collector tank SA in a sectional view as a cuboid receiving body, which is covered on its upper face by a cover DE. This cover DE may be connected to the relevant receiving body, for example by a snap connection arrangement. At its end shown in FIGS. 6 and 7 to the right, the relevant receiving body of the collector tank SA has a grip GR by which the collector tank SA may be inserted into a corresponding receiver opening of an appliance body GK of the washing and/or laundry dryer. FIG. 6 shows the collector tank SA in a state in which said collector tank is inserted fully into a receiver opening GO of the appliance body GK and FIG. 7 shows the case where the collector tank SA is slightly withdrawn from this receiver opening of the appliance body GK.

In the state inserted into the aforementioned receiver opening GO, the collector tank SA bears with its end region shown to the left in FIG. 6 against buffers PU, which are in contact from the inside of the receiver opening GO receiving the collector tank SA. In this state, the collector tank SA is received by cam receivers NA1 and NA2 for cams NO1 and/or NO2, provided in its underside which protrude from the underside of the relevant receiver opening GO. In this state, the collector tank SA is lowered relative to the underside of the aforementioned receiver opening GO of the appliance body GK and thus bears by means of a sealing member in the form of a sealing disk DI sealingly against the underside of the aforementioned receiver opening GO. As a result, possible rising damp process air in the downpipe FR may neither reach the collector tank SA nor the outside of the appliance body GK. In this state, the outlet opening AU in the lower region of the collector tank SA is also closed, and namely by a closure plate TE which bears sealingly against sealing regions and/or lips DL which protrude from the lower inner face of the collector tank SA.

When withdrawing the collector tank SA from the aforementioned receiver opening GO by means of the grip GR, the underside of the collector tank SA slides on the cams NO1 and NO2 and thus prevents damage or wear to the sealing disk D1, as is visible in FIG. 7.

In the position shown in FIG. 6 of the collector tank SA, two through-openings OP1 and OP2 are aligned relative to one another, of which the through-opening OP1 is provided in the rear region of the aforementioned receiver opening GO of the appliance body GK and of which the through-opening OP2 is provided in the corresponding region of the cover DE of the collector tank SA. By these through-openings aligned with one another, which preferably are of the same size, condensate water is fed through the connecting channel K2 shown in FIG. 5 into the collector tank SA. In this collector tank SA the partition wall TW is indicated, which has already been mentioned when considering the collector tank SA shown in FIG. 5. As is visible from FIGS. 6 and 7, the height of the partition wall TW is lower than the height of the interior of the collector tank SA.

The closure plate TE shown in FIGS. 6 and 7 is borne by a short support part and/or support pin TT1, which is received in a through-opening contained in the bottom part of the collector tank SA, so that the collector tank SA may be displaced by the closure plate TE relative to the aforementioned receiver opening GO.

In the position of the collector tank SA shown in FIG. 6, an actuating pin TT2 opposing the support pin TT1 is located in a corresponding through-opening which is provided in the bottom region of the aforementioned receiver opening GO. On this actuating pin TT2 an actuating arrangement acts which comprises an actuating device BE which may be activated by the control device ST shown in FIG. 5 as well as the bistable spring FE. This bistable spring FE formed, for example, by a leaf spring which is preferably provided with a jump function, is borne at its bearing point by a fixedly arranged support part TL, around which the relevant bistable spring FE may be snapped upon actuation. At the end of its relatively short pivoting range away from the support part TL, the bistable spring FE is connected to a plunger of the actuating device BE. This actuating device BE may preferably be an actuating device operating thermally or electromechanically, such as a thermal relay or a magnetic relay, which may be activated by the control device ST1 (from the output connection A4b thereof according to FIG. 5). By the transformation ratio between the pivoting ranges of the bistable spring FE, provided on both sides of the support part TL, a relatively short stroke of the plunger of the actuating device BE may correspondingly trigger a substantially greater stroke of the closure plate TE (lever principle), and namely preferably due to the bistable jump function of the spring FE, so that the condensate water contained in the rinsing chamber SB2 may be discharged as a water surge through the downpipe FR and the rinsing nozzle DU to the evaporator EV according to FIG. 5.

A corresponding activation of the actuating device BE by the control device ST, as is shown in FIG. 5, has the effect that by switching the bistable spring FE the actuating pin TT2 forces up the support pin TT 1 and thus lifts the closure plate TE from its sealed support against the sealing lips DL. In this manner, the rinsing chamber separated by the partition wall TW in the collector tank SA is directly connected to the downpipe FR and may discharge the condensate water collected in this rinsing chamber in a surge-like manner through the downpipe FR.

FIG. 8 shows a plan view of the collector tank SA shown in FIGS. 6 and 7, with the cover DE removed. As is visible in FIG. 8, the partition wall TW extends in the interior of the collector tank SA initially from the left end thereof shown, in an almost semi-circular manner. This region denoted by EL, represents the inlet region for the condensate water, which is pumped through the aforementioned connecting channel K2 into the collector tank SA. To this inlet region EL, therefore, a narrowed region EN is adjoined, which then passes into a widened region, which serves as a rinsing region of the rinsing chamber SB. The relevant partition wall TW thus runs toward the lower side wall of the collector tank SA shown in FIG. 8 and thus subdivides the interior of the collector tank SA into the already mentioned rinsing chamber SB and into the storage chamber SP visible in FIG. 8. In the aforementioned rinsing chamber SB is located the outlet opening AU mentioned in connection with FIGS. 6 and 7, which in this case is shown without a closure member, as in the closure plate mentioned in connection with FIGS. 6 and 7. The bottom region inside the rinsing chamber SB may be formed, as indicated in FIG. 8 by dotted lines, so that this bottom region to a certain extent runs in a funnel-shaped manner to the outlet opening AU. As a result, the outlet of the condensate water collected in the rinsing chamber SB through the outlet opening AU may be further assisted. Condensate water runs from the rinsing chamber SB into the aforementioned storage chamber SP of the collecting tank SA, only via the partition wall TW after the rinsing chamber SB has been filled with condensate water.

In FIG. 8, on the outer longitudinal sides of the collector tank SA guide pins and/or guide rollers FS are indicated by dotted lines. The guide pins and/or rollers FS thus provided on each outer side of the collector tank SA shown in FIG. 8 may respectively be received by a guide track FB of a guide rail FU, one of which being shown in FIG. 9. Two such guide rails are attached relative to the relevant longitudinal sides of the collector tank SA on the inside of the receiver opening GO, mentioned with reference to FIGS. 6 and 7. These guide pins and/or rollers FS and the corresponding guide rails with their guide tracks for the relevant guide pins and/or rollers FS may be provided alternatively to the cams N01, NO2 and cam receivers NA1, NA2 shown in FIGS. 6 and 7.

The aforementioned guide rails FU may, for lowering the collector tank SA in the fully inserted state thereof according to FIG. 6 in the aforementioned receiver opening GO, respectively contain recessed regions AB 1 and AB2, in which the corresponding guide pins and/or rollers FS of the collector tank SA may be received. It should be noted here that naturally the guide track FB shown in FIG. 9 may be provided with guide tracks corresponding to its recessed regions AB 1 and AB2 in the longitudinal outer sides of the collector tank SA shown in FIG. 8, and in that the receiver opening GO mentioned with reference to FIGS. 6 and 7 may be provided with corresponding guide pins and/or rollers which make it possible to receive the collector tank SA with its guide track FB. In this case, however, the respective guide track FB is provided with its recessed regions AB1 and AB2 in the respective longitudinal outer face of the collector tank SA, so that it is open at the end shown to the left in FIG. 8 and has recessed regions AB 1 and AB2 oriented toward the opposing end. Thus for the individual guide pins and/or rollers specific guide tracks may be provided with individual recessed regions.

Finally, it should also be noted that the device according to the present invention may also be produced in a different manner from that explained above. Thus it is possible, for example, to design the collector tank SA by means of the partition wall TW as an at least approximately round central rinsing chamber SB and as a storage chamber SP surrounding said rinsing chamber. In this case, the funnel-shaped recess of the outlet opening AU mentioned in connection with FIG. 4 in the bottom region of the rinsing chamber may be particularly easily produced. Also, the actuating device for the abrupt opening of the relevant outlet opening AU may be constructed in a different manner from that explained above.

### LIST OF REFERENCE NUMERALS

| | |
|---|---|
| A0, A1, A2, A3 A4a, A4b, A5, A6 | Output connections |
| AB1, AB2 | Recessed regions |
| AU | Outlet opening |
| BE | Actuating device |
| BV | Movable connecting part |
| DE | Cover |
| DI | Sealing member and/or disk |
| DL | Sealing regions and/or lips |
| DU | Rinsing nozzle |
| E1, E2 | Input connections |
| EN | Narrowed region |
| EL | Inlet region |
| EV | Evaporator |
| FB | Guide track |
| FE | Bistable spring |
| FR | Downpipe |
| FS | Guide pin and/or roller |
| FU | Guide rail |
| GB | Fan |
| GK | Appliance body |
| GO | Receiver opening |
| GR | Grip |
| GW | Threaded spindle |
| HE | Heating device |
| K1, K2, K3, K4, K5, K6 | Connecting channels |
| KW | Condensate water pan |
| LA | Plates |
| LU1, LU2 LU3, LU4 | Process air channels |
| MO | Electric motor, motor |
| MU | Nut part |
| NA1, NA2 | Cam receiver |
| NO1, NO2 | Cam |
| OP1, OP2 | Opening |
| P1, P2 | Pump |
| PU | Buffer |
| RK | Return channel |
| S1, S2 | Switch |
| SA | Collector tank |
| SB1 | Rinsing tank |
| SB2 | Rinsing chamber |
| SP1 | Storage tank |
| SP2 | Storage chamber |
| SL | Support bearing |
| ST | Control device |
| TE | Closure plate |
| TL | Support part |
| TR1, TR2 | Funnel-shaped connectors |
| | (transition parts) |
| TT, TT1 | Support part |
| TT2 | Actuating pin |
| TW | Partition wall |
| U | Voltage connection |
| UB | Overflow tank |
| VE | Distributor and/or two-way valve |
| VT1, VT2 | Closure part |
| WA | Water feed pipe |
| WT | Washing or laundry drum |
| ZR | Water discharge pipe |

1-15. (canceled)

16. A home appliance comprising:
an evaporator of a condenser in a process air circuit;
a condensate water pan that collects water condensed by the evaporator from drying of process air;
a collector tank above the evaporator having one of a rinsing tank and a rinsing chamber with a storage chamber as an overflow region, the tank further including an abruptly openable outlet; and
a downpipe connected to the abruptly openable outlet to permit discharge of condensate water in the collector tank in a surge to the evaporator.

17. The home appliance of claim 16, further comprising a mains water supply pipe connected to the downpipe.

18. The home appliance of claim 16, wherein the downpipe has a region which is narrowed relative to a cross section of the outlet of the collector tank.

19. The home appliance of claim 16, further comprising a rinsing nozzle fixedly connected to the downpipe at an inlet region of process air to the evaporator.

20. The home appliance of claim 16, wherein an outlet of the downpipe is deflectable from a starting region at an inlet region of process air into the evaporator to an end region at an outlet region of process air from the evaporator.

21. The home appliance of claim 16, further comprising a pump connected to the condensate water pan and the collector tank.

22. The home appliance of claim 16, further comprising a bistable spring for actuating the abruptly openable outlet.

23. The home appliance of claim 22, further comprising one of a thermal relay or a magnetic relay for actuating the bistable spring.

24. A method for cleaning an evaporator of a condenser device, the method comprising
obtaining rinsing water from condensate water in a process air circuit from the drying of damp laundry and collected in a condensate water pan;
feeding the rinsing water from the condensate water pan to a rinsing tank above the evaporator; and
discharging the rinsing water from an outlet side of the rinsing tank to the evaporator by abruptly opening the rinsing tank or discharging mains water under pressure to the evaporator.

25. The method of claim 24, wherein the discharging comprises substantially equalizing the discharge quantity between a start and a finish of the discharging.

26. The method of claim 24, wherein the discharging comprises discharging to the evaporator at a fixed distance from an inlet of process air to the evaporator.

27. The method of claim 24, wherein the discharging comprises deflecting the discharging from a starting region at a fixed distance from an inlet region of process air to the evaporator to an end region at another distance in a direction of an outlet region of process air from the evaporator.

28. The method of claim 24, wherein the feeding comprises pumping the rinsing water from the condensate water pan into the rinsing tank and/or a rinsing chamber of a collecting chamber.

29. The method of claim 24, wherein the discharging comprises abruptly opening the rinsing tank by actuating a bi-stable closure.

30. The method of claim 29, wherein actuating the closure comprises one of thermally actuating and electromagnetically actuating the closure.
